(19) United States
(12) Patent Application Publication
(10) Pub. No.: US 2014/0192146 A1
(43) Pub. Date: Jul. 10, 2014

(54) APPARATUS AND METHOD FOR DISPLAYING HOLOGRAM IMAGE

(71) Applicant: Electronics and Telecommunications Research Institute, Daejeon (KR)

(72) Inventors: Min Sik PARK, Sejong (KR); Kyung Ae MOON, Daejeon (KR); Jin Woong KIM, Daejeon (KR)

(73) Assignee: Electronics and Telecommunications Research Institute, Daejeon (KR)

(21) Appl. No.: 14/094,704

(22) Filed: Dec. 2, 2013

(30) Foreign Application Priority Data
Jan. 10, 2013 (KR) 10-2013-0002953

(51) Int. Cl. G03H 1/04; H04N 13/04

(52) U.S. Cl. CPC G03H 1/0443; H04N 13/0484
USPC 348/40

(57) ABSTRACT

Provided is an apparatus and method for displaying a hologram image that may display a hologram image created by tracking a position of a pupil of a user using an acquired user image, tracking a position of a light source of a reflection hologram image that is reflected from appearance of the user, and by correcting a position of a light source of a display hologram image based on the position of the pupil of the user.

### CROSS-REFERENCE TO RELATED APPLICATION

This application claims the priority benefit of Korean Patent Application No. 10-2013-0002953, filed on Jan. 10, 2013, in the Korean Intellectual Property Office, the disclosure of which is incorporated herein by reference.

### BACKGROUND

1. Field of the Invention

Embodiments of the present invention relate to a hologram image displaying apparatus and method that may match a position of a hologram viewing window and a position of a pupil of a user.

2. Description of the Related Art

In the case of a stereoscopic display using a general stereo matching technology, a mismatch may occur between a focal convergence angle and focus accommodation information. Here, the focal convergence angle is used to rotate pupils of both eyes toward the middle of the forehead to be focused on a feature point of a three-dimensional (3D) object, and the focus accommodation information is used to adjust a thickness of a crystalline lens that serves as a lens role in order to be focused at a corresponding distance.

A user may view a left image and a right image that are projected from different viewpoints, using a display. Even though the user views an object through a two-dimensional (2D) image, the user may recognize the object as a 3D object due to parallax between the left image and the right image.

The user may move a gazing point by changing convergence angles of pupils of both eyes in order to be focused on a predetermined area of a 3D object virtually present in front and at the rear of a display plane.

However, even though the user changes a gazing point to the front and the rear of the display plane, the user may be substantially focused on the display plane positioned at a fixed distance. Accordingly, correspondence information between a gazing point of the user and a convergence focus in the case of viewing a 3D object in the real world may not match correspondence information between a gazing point of a user and a convergence focus in the case of viewing the 3D object through an autostereoscopic display. Mismatching correspondence information may aggravate the confusion of the user, and may cause discomfort and fatigues of eyes.

As an alternative, proposed is a holographic display capable of enhancing mismatch between focal convergence angles of both eyes and focus accommodation information of a crystalline lens. The holographic display may form an object image through the wave front modulated in free space so that the object image may have 3D information even though the object is not present in actual space, by controlling and modulating the wave front coming from a light source.

The holographic display of modulating the wave front may correspond to a spatial light modulator (SLM). The SLM may include a liquid crystal display (LCD) that is widely used as a TV screen, a liquid crystal on silicon (LCoS) that is used as an image displaying apparatus in a beam projector, a digital micro-mirror device (DMD), and the like.

In the case of producing a large TV screen using the holographic display, the LCD may be appropriate for large production among the above devices included in the SLM. Arrangement of LCD pixels may function as a diffraction grating to thereby modulate the wave front of a light source through diffraction. Also, a diffraction angle of a hologram image may have a significantly close relation with a viewing angle of the holographic display. The diffraction angle is in an inverse proportion to a pixel pitch that is an interval between pixels that constitute an LCD SLM.

In the case of viewing a hologram reproduced for both eyes using at least 40-inch LCD to which the holographic display is adapted, the minimum pixel pitch may need to be within 1 μm. However, many LCDs currently commercialized have a pixel pitch of 100 μm or more and thus, may have a narrow viewing window with which a user may view using only a single pupil of the user due to a very small diffraction angle. Accordingly, an imaging apparatus using the holographic display may need to move the viewing window by controlling a position of a light source based on a position of a pupil of a user, and to accurately emit the wave front modulated light source toward the pupil of the user.

However, due to an error in tracking a position of a pupil of a user that occurs in the case of calculating the position of the pupil based on a 3D position of the pupil, an error in controlling a position of a light source that occurs in the case of locating the light source at the position of the pupil, aberration of an optical condensing lens, and the like, the position of the pupil of the user and the position of the viewing window may mismatch. Accordingly, the user may have difficulty in clearly observing a 3D image reproduced through a hologram.

In the case of the error in tracking the position of the pupil of the user, it may be possible to increase accuracy of the position of the pupil by enhancing resolution of a pupil image, but there are some constraints in increasing the accuracy. Accordingly, the above issue may be generally solved by enlarging a size of the viewing window to be greater than a size of the pupil. The size of the viewing window may be calculated to be proportional to (λ×D)/ρ. Here, the accuracy of the position of the pupil may be increased by decreasing pixel pitch ρ of an LCD SLM. However, in terms of techniques and costs, it is difficult to develop the LCD SLM with a small pixel pitch sufficient to obtain a satisfactory viewing window. Further, in terms of costs or physical respect, there are some constraints in decreasing the error in controlling the position of the light source or aberration of an optical condensing lens, which is another factor that causes mismatch between the position of the pupil of the user and the position of the viewing window.

### SUMMARY

According to an aspect of the present invention, there is provided an apparatus for displaying a hologram image, the apparatus including: an image acquiring unit to acquire a user image; an image analyzer to track a position of a pupil of a user using the user image, and to track a position of a light source of a reflection hologram image that is reflected from appearance of the user; a hologram creator to create a display hologram image corresponding to the position of the pupil of the user; a light source provider to control a position of a light source of the display hologram image based on the position of the pupil of the user; and a hologram display unit to display the display hologram image.

The image acquiring unit may include: a user image camera to acquire a pupil image of the user; and an infrared (IR) image camera to acquire the reflection hologram image that is created by an IR light that is diffracted from the hologram display unit and thereby reflected.

The user image camera may include a three-dimensional (3D) position tracking camera to track a 3D position of the pupil of the user in 3D space.

The image analyzer may calculate a mismatching level between a position of a viewing window and the position of the pupil of the user based on the reflection hologram image.

The light source provider may control the position of the light source to match a position of the viewing window.

The image analyzer may analyze a center position error between a center position of the viewing window and a center position of the pupil of the user that is analyzed from the reflection hologram image, and may transmit the analyzed center position error to the light source provider.

The light source provider may correct the center position of the viewing window and the center position of the pupil of the user to be matched therebetween based on the center position error.

The image analyzer may analyze a blurring level of the reflection hologram image and may transmit the blurring level to the light source provider.

The hologram creator may create the display hologram image using points that are configured by a 3D image acquired at the position of the pupil of the user.

The hologram display unit may include a light condensing unit to condense, on the pupil of the user, the light source of which wave front is modulated through the display hologram image.

According to another aspect of the present invention, there is provided a method of displaying a hologram image, the method including: acquiring a user image; tracking a position of a pupil of a user using the user image; tracking a position of a light source of a reflection hologram image that is reflected from appearance of the user; creating a display hologram image corresponding to the position of the pupil of the user; controlling a position of a light source of the display hologram image based on the position of the pupil of the user; and displaying the display hologram image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a holographic display according to an embodiment of the present invention;

FIG. 2 is a block diagram illustrating a configuration of an apparatus for displaying a hologram image according to an embodiment of the present invention;

FIG. 3 is a diagram illustrating a positional relationship among a hologram image displaying apparatus, a pupil, and a viewing window according to an embodiment of the present invention;

FIG. 4 is a diagram illustrating a positional relationship between a center of a pupil and a center of a viewing window according to an embodiment of the present invention.

FIG. 5 is a diagram illustrating an example of calculating a position error of a viewing window according to an embodiment of the present invention;

FIG. 6 is a diagram illustrating a blurring phenomenon that occurs due to a focal distance error according to an embodiment of the present invention; and

FIG. 7 is a flowchart illustrating a method of displaying a hologram image according to an embodiment of the present invention.

### DETAILED DESCRIPTION

Reference will now be made in detail to exemplary embodiments of the present invention, examples of which are illustrated in the accompanying drawings, wherein like reference numerals refer to like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

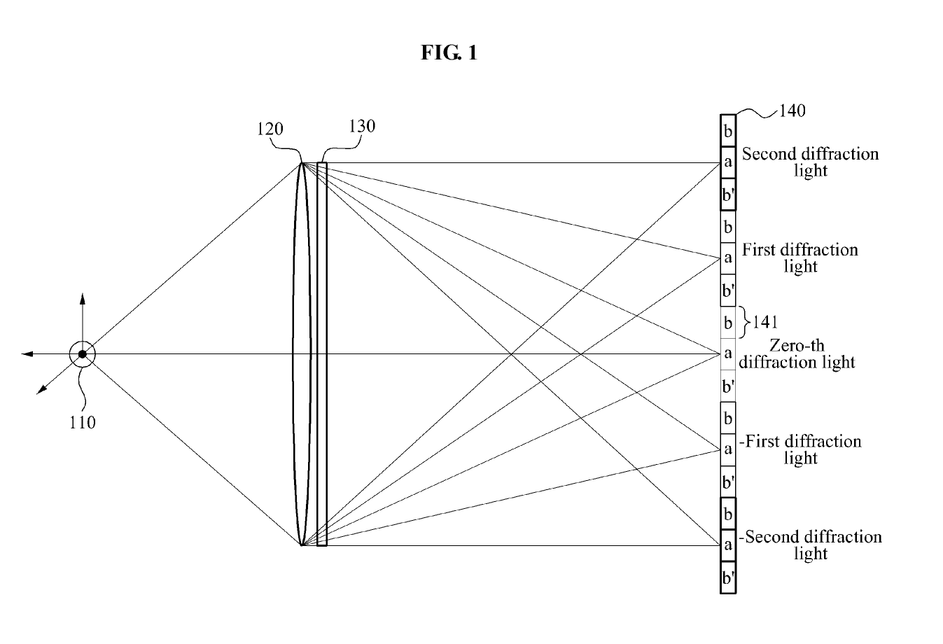

FIG. 1 is a diagram illustrating an example of a holographic display according to an embodiment of the present invention.

Referring to FIG. 1, a hologram image displaying apparatus according to an embodiment of the present invention may reproduce a three-dimensional (3D) image by modulating a light wave front coming from a backlight 110, which is a rear light source, through a hologram pattern, and may provide the reproduced 3D image to a user. Here, a liquid crystal display (LCD) spatial light modulator (SLM) 130 may be used as an amplitude modulation apparatus or a detour phase modulation apparatus. Each pixel may function as an aperture to thereby form a diffraction grating. Accordingly, a pixel may generate an N-th diffraction light, such as a zero-th diffraction light, a first diffraction light, and a -first diffracting light, for example, by diffracting the light emitted from a light source that is positioned at the rear of the LCD SLM 130, and may project the generated diffraction light onto a hologram image plane 140.

Referring to FIG. 1, the user may view the 3D image alike in areas “b” and “b” that are provided above and below an area “a” in which the intensity of N-th diffraction light becomes maximum. The hologram image displaying apparatus may use, as a hologram viewing window 141, the area “b” in which the 3D image may be observed.

An interval between N-th diffraction lights may be calculated according to a grating equation, that is, (λ×D)/ρ. Here, λ denotes a wavelength of light, D denotes a distance between the SLM 130 and a pupil of the user, and ρ denotes a pixel pitch of the SLM 130. A size of the viewing window in which the user may observe the 3D image may be about ⅓ of the above interval.

When the hologram image displaying apparatus indicates, on the SLM 130, a hologram that is generated as a computer generated hologram (CGH) with respect to the 3D object and then emits light from the backlight 110, the user may view the 3D image that is reproduced through hologram viewing windows positioned to correspond to positions of pupils of left and right eyes of the user.

According to an embodiment, when the user moves, positions of the pupils of left and right eyes may also be changed and thus, left and right hologram viewing windows may need to be changed. A position of a pupil may be calculated using an image processing technology by acquiring a pupil image of the user.

The hologram image displaying apparatus may move a hologram viewing window by changing a position of a light source based on the calculated position of the pupil. Here, the position of the light source based on the position of the pupil may be calculated through a geometrical calculation.

When a center of a pupil and a center of a hologram viewing window do no match due to a pupil position (x, y, z coordinate values) error, a light source position error, and the like, the hologram image displaying apparatus may find an area “a” of zero-th diffraction light that is reflected from a face of the user, and may place the found area “a” right below the pupil and thereby control a position of a light source so that a viewing window “b” and the pupil may match.

In the case in which a peripheral lighting is brighter than the area “a” since the area “a” of the zero-th diffraction light corresponds to a visible light band, the brightness of the area “a” reflected from the face of the user may become relatively dark and thus, it is difficult to identity a corresponding position. In this case, by diffracting a visible white light required for hologram reproduction and an infrared (IR) light through the SLM 130 using a light source of an IR wavelength which is insensitive to the peripheral lighting, and by processing an image acquired through a camera that enables only light of the corresponding IR wavelength to pass, it is possible to easily recognize a position of the area “a” of zero-th diffraction light of the IR light.

According to an embodiment, a position of an area “a” of zero-th diffraction light is identical for light of any wavelength and thus, a position of an area “a” of zero-th diffraction light of an IR light source may be regarded as a position of an area “a” of zero-th diffraction light of a white light. Further, the maximum intensity of N-th diffraction light may decrease according to an increase in an order, depending on functions. Accordingly, an area having the largest intensity among a plurality of orders recognized through the image processing technology may be identified as the area “a” of the zero-th diffraction light.

According to an embodiment, when an area “a” of zero-th diffraction light is not focused on the hologram image plane 140, a blurring phenomenon may occur and as a consequence, a 3D image plane may not be clearly viewed. Accordingly, the hologram image displaying apparatus may be focused on the hologram image plane 140 that includes the area “a” of the zero-th diffraction light while vertically moving a position of a light source and also moving the light source forward and backward in order to locate the area “a” of the zero-th diffraction light right below the pupil. The hologram image displaying apparatus may measure a spreading level of light focused on the area “a” of the zero-th diffraction light by controlling the position of the light source, and may find a position at which the spreading level of light is smallest.

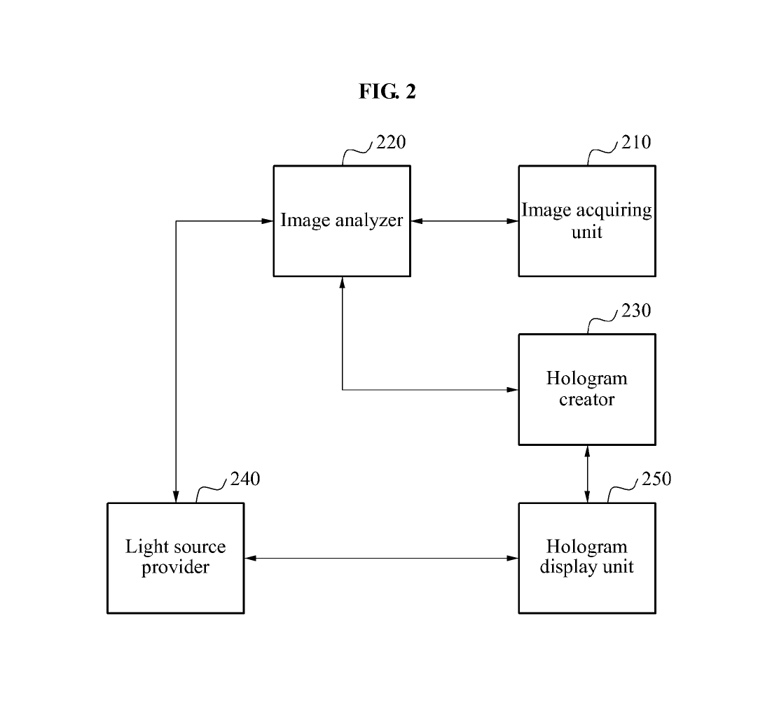

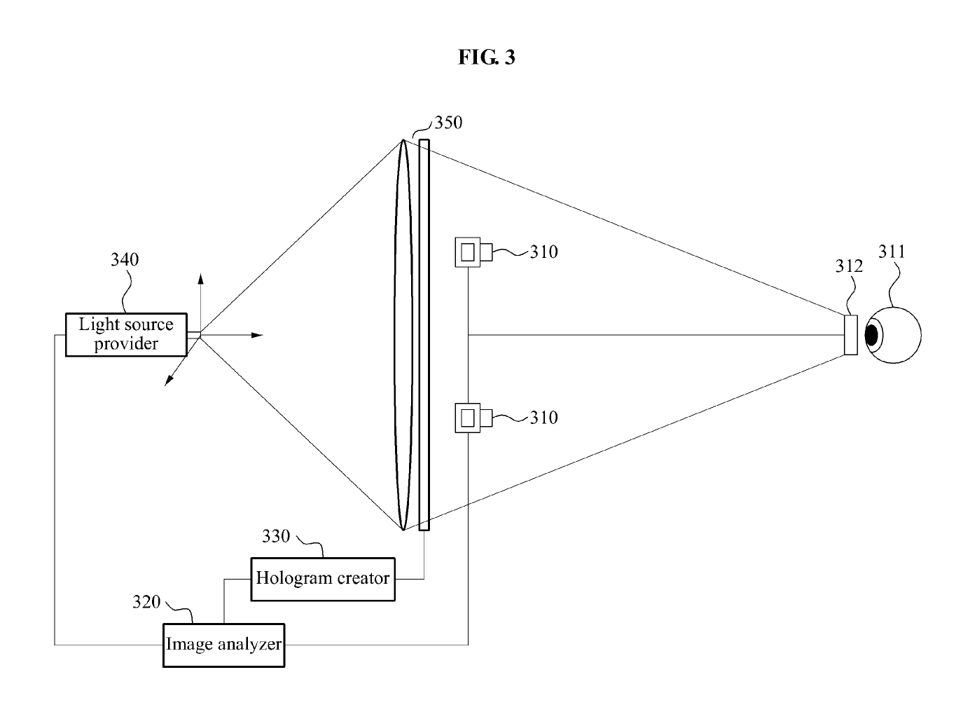

FIG. 2 is a block diagram illustrating a configuration of an apparatus for displaying a hologram image according to an embodiment of the present invention, and FIG. 3 is a diagram illustrating a positional relationship among a hologram image displaying apparatus, a pupil, and a viewing window according to an embodiment of the present invention.

Referring to FIG. 2, the hologram image displaying apparatus may include an image acquiring unit 210, an image analyzer 220, a hologram creator 230, a light source provider 240, and a hologram display unit 250. Also, referring to FIG. 3, the hologram image displaying apparatus may include an image acquiring unit 310, an image analyzer 320, a hologram creator 330, a light source provider 340, and a hologram display unit 350

The image acquiring units 210 and 310 may acquire a user image. For example, the image acquiring units 210 and 310 may acquire, using a camera, a user image acquired to track a position of a pupil of a user, and to control a position of a light source.

The image acquiring units 210 and 310 may include a user image camera to acquire a pupil image of the user, and an IR image camera to acquire a reflection hologram image that is created by an IR light that is diffracted from the corresponding hologram display units 250 and 350 and thereby reflected. The user image camera may include a 3D position tracking camera for tracking a 3D position of the pupil of the user in 3D space.

A user image acquiring camera may include a plurality of 3D position tracking cameras, such as a stereo camera, a time of flight (ToF) depth camera, a structured light camera, and the like, for example, in order to find a 3D position (x, y, z) of the pupil of the user in the 3D space.

A 3D position tracking camera may be operated in a visible light area, and may also be used as a camera that is operated in an IR area in order to obtain an image required to predict an accurate position of a pupil of a user when a change in a lighting is serious or the lighting is dark in a viewing environment.

An IR lighting capable of irradiating an IR light toward a user may be added to the hologram image displaying apparatus. Further, in order to obtain a resolution of a pupil image required to predict an accurate position of the pupil of the user, a zoom function capable of optically enlarging the pupil of the user may be added.

To obtain a desired lighting environment and resolution of the pupil image, the hologram image displaying apparatus may employ a configuration of a camera system in which the aforementioned apparatuses are combined using a plurality of schemes.

An IR image acquiring camera may provide a white light of a visible light area so that the light source providers 240 and 340 may observe a hologram image, and may also provide an IR light to make it possible to find an area “a” in which the intensity of zero-th diffraction light is maximum. Accordingly, the IR image acquiring camera may include an optical lens system, for example, an image sensor such as a charged coupled device (CCD), a complementary metal-oxide semiconductor (CMOS), and the like, which enables only a corresponding IR wavelength to pass, to make it possible to acquire only an IR image that is diffracted from the hologram display units 250 and 350 and is reflected from the face of the user.

The image analyzers 220 and 320 may track a position of a pupil of the user using the user image, and may track a position of a light source of a reflection hologram image that is reflected from the appearance of the user. For example, the image analyzer 220 and 320 may track the pupil of the user using the acquired user image, and may also track a position of a light source of a hologram image that is reflected from the face or the pupil of the user and is not diffracted.

The image analyzers 220 and 320 may calculate a mismatching level between a position of a viewing window and the position of the pupil of the user based on the reflection hologram image. The image analyzers 220 and 320 may analyze a center position error between a center position of the viewing window and a center position of the pupil of the user that is analyzed from the reflection hologram image, and may transmit the analyzed center position error to the light source providers 240 and 340. Also, the image analyzers 220 and 320 may analyze a blurring level of the reflection hologram image and transmit the blurring level to the light source providers 240 and 340.

The image analyzers 220 and 320 may calculate a position of the pupil image based on the user image acquired from the corresponding image acquiring units 210 and 310 using image processing technology, and may calculate a mismatching level between the position of the viewing window and the position of the pupil based on an IR image acquired from the IR image acquiring units 210 and 310.

The image analyzers 220 and 320 may transfer the calculated position of the pupil of the user to the light source providers 240 and 340, and thereby control the position of the light source to match the position of the viewing window.

In preparation for a case in which it is impossible to view a clear 3D image restored from a hologram image due to a blurring phenomenon that occurs by a light source defocused on a pupil, the image analyzers 220 and 320 may transfer an error level between a center of the pupil of the user and a center of the viewing window and a blurring level to the light source providers 240 and 340, and thereby control the position of the light source so that the light source may be well focused on the pupil.

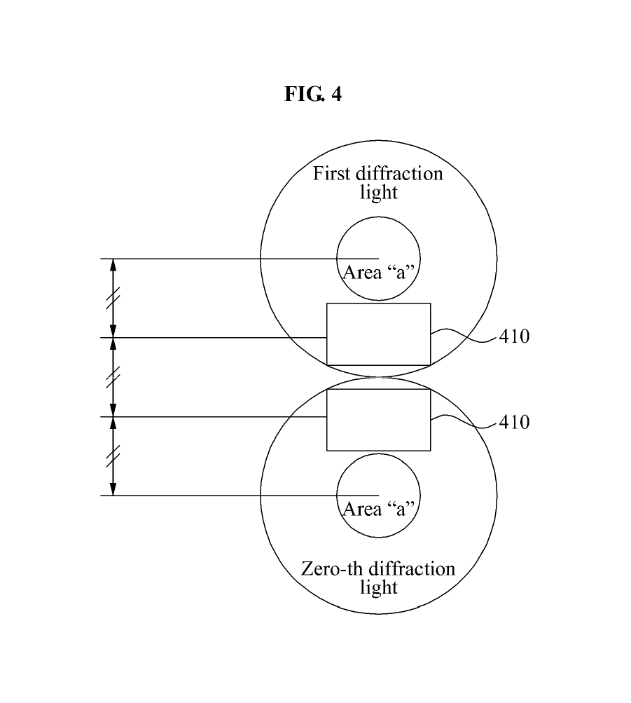

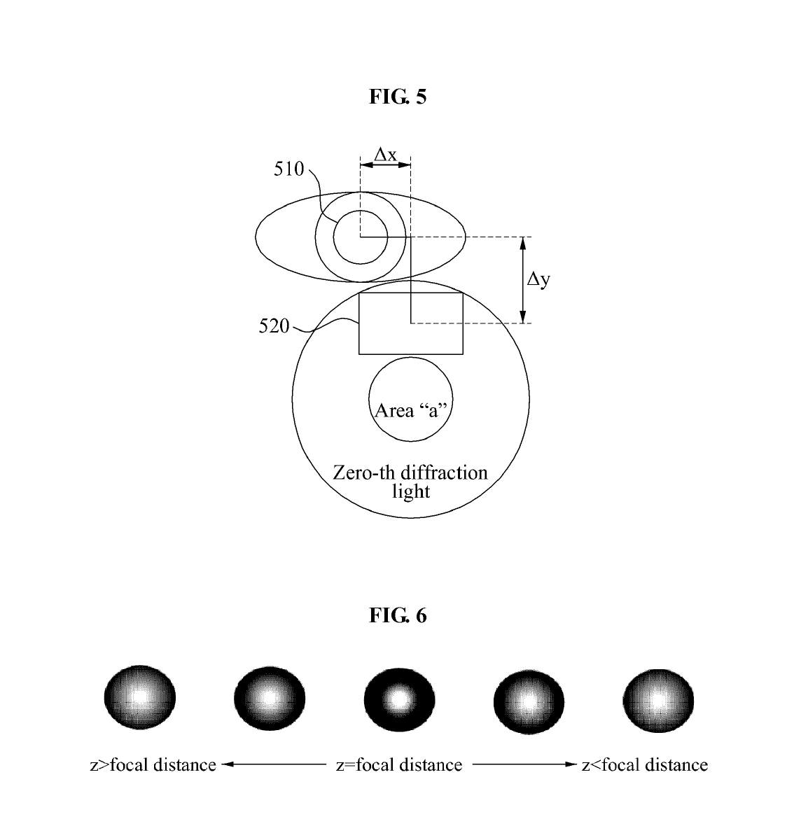

FIG. 4 is a diagram illustrating a positional relationship between a center of a pupil and a center of a viewing window according to an embodiment of the present invention, FIG. 5 is a diagram illustrating an example of calculating a position error of a viewing window according to an embodiment of the present invention, and FIG. 6 is a diagram illustrating a blurring phenomenon that occurs due to a focal distance error according to an embodiment of the present invention.

Referring to FIG. 4, a hologram image displaying apparatus according to an embodiment of the present invention may calculate a position error between a center of a pupil and a center of a viewing window 410 by performing image processing with respect to a zero-th diffraction light of an IR image that is reflected from a face of a user, a center of an area “a”, and a center of an area “a” of first diffraction light, and may calculate, as the center of the viewing window 410, a point corresponding to a third of a distance between two centers.

Through the aforementioned calculation process, the hologram image displaying apparatus may express an error between a center of a pupil 510 and a center of a viewing window 520 using Δx and Δy, as illustrated in FIG. 5.

Referring to FIG. 6, a focal error of a light source may be calculated as a spreading level of brightness while getting along the edge from a center of an area “a” of zero-th diffraction light that is reflected from a face of a user. As an example, assuming the brightness of the area “a” as a Gaussian distribution, the focal error of the light source may be calculated using a sync function or a distribution of Gaussian closest thereto. As another example, a spreading level of brightness of the area “a” may be calculated using a ratio of a brightness value of edge of the area “a” of the zero-th diffraction light to a brightness value of the center portion thereof

Referring again to FIGS. 2 and 3, the hologram creators 230 and 330 may create a display hologram image corresponding to the position of the pupil of the user.

The hologram creators 230 and 330 may create the display hologram image using points that are configured by a 3D image acquired at the position of the pupil of the user. For example, the hologram creators 230 and 330 may quickly create a hologram image using points that constitute a 3D image capable of being observed at the position of the pupil of the user transferred from the image acquiring units 220 and 320.

The light source providers 240 and 340 may control the position of the light source of the display hologram image based on the position of the pupil of the user. For example, the light source providers 240 and 340 may also provide a white light or an IR light as a light source, and may control the position of the light source based on the position of the pupil of the user.

The light source providers 240 and 340 may control the position of the light source to match the position of the viewing window. The light source providers 240 and 340 may correct the center position of the viewing window and the center position of the pupil of the user to be matched therebetween based on the center position error. The light source providers 240 and 340 may provide the hologram display units 250 and 350 with a high luminance light emitting diode (LED) based white light source or a white light source in which red, green, and blue laser light sources having relatively strong temporal/spatial coherence are multiplexed into one, so that the hologram display units 250 and 350 may reproduce a hologram image.

Also, the light source providers 240 and 350 may provide an IR light source, for example, an LED light source and a laser diode light source, having sufficient intensity for the image acquiring units 210 and 220 to acquire a clear IR image that is projected from the hologram display units 250 and 350, and is reflected from the face of the user.

The hologram image displaying apparatus may multiplex an IR light source emitted from the light source providers 240 and 340 to constitute a single light source with a white light source, or may configure the IR light source to be positioned at the same position as the white light source, so that a position of zero-th diffraction light of white light source diffracted from the hologram display units 250 and 350 may physically match a position of zero-th diffraction light of IR light source.

Also, the light source providers 240 and 340 may control a position of white light source so that the center of the pupil of the user may match the center of the viewing window based on 3D position information about the pupil of the user that is calculated by the image analyzers 220 and 320 from the user image. The light source providers 240 and 340 may also generate in advance a lookup table or an equation required to calculate the position of the light source corresponding to the position of the pupil.

Also, the light source providers 240 and 340 may provide the user with a 3D image that is further clearly reproduced from a hologram image, by correcting a position of the light source based on focus error information of the light source and error information between the center of the pupil and the center of the viewing window that is calculated by the image analyzers 220 and 320 from an IR image.

The light source providers 240 and 340 may employ, as a method of controlling a position of a light source, a method of mechanically moving a position of a light source based on a holographic input/output optical system configuration scheme, a method of electronically controlling a position of a light source through on/off of a light shutter, and the like.

The hologram display units 250 and 350 may display a display hologram image. For example, the hologram display units 250 and 350 may display a generated hologram on an SLM. Also, the hologram display units 250 and 350 may include a light condensing unit (not shown) to condense, on the pupil of the user, the light source of which wave front is modulated through the display hologram image.

The hologram image displaying apparatus may be configured as two sets in order to support both eyes of the user. The two sets may form hologram viewing windows corresponding to the left eye and the right eye, respectively.

The hologram display units 250 and 350 may include an SLM to display the hologram image created from the hologram creators 230 and 330, and a light condensing system to condense, on the pupil of the user, the light source of which wave front is modulated through the SLM. The SLM may include an LCD device, and the light condensing system may employ a convex lens for collecting a light source, a reticular lens, and the like. Also, plural types of lenses for removing aberration of light source may be combined.

The hologram display units 250 and 350 may update the SLM with a hologram image newly created by the hologram creators 230 and 330 based on the position of the pupil of the user.

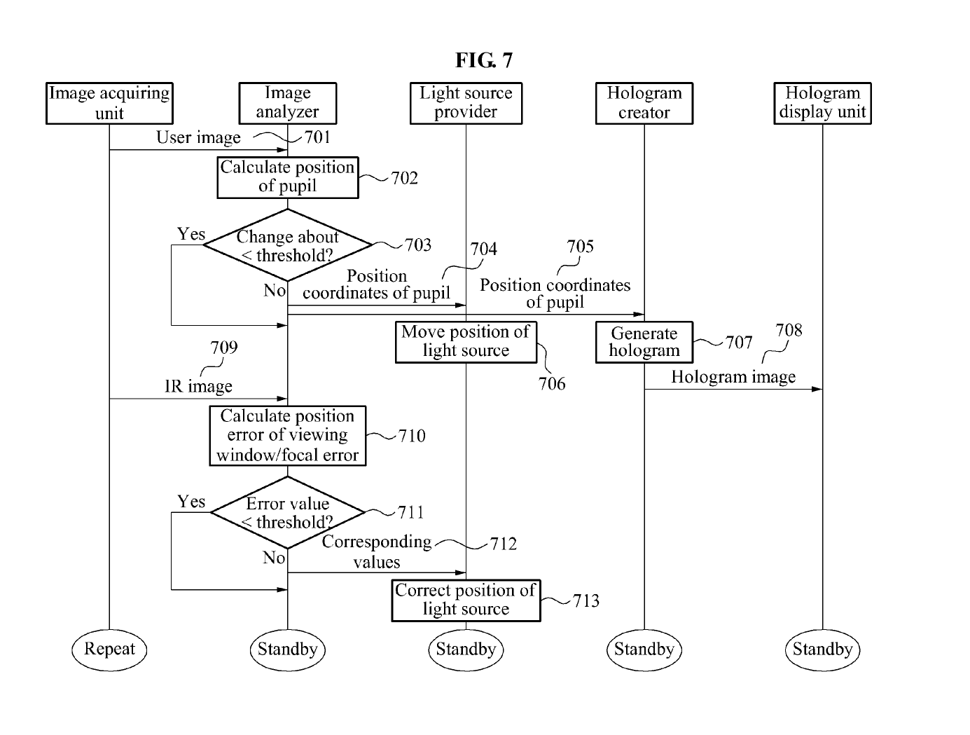

FIG. 7 is a flowchart illustrating a method of displaying a hologram image according to an embodiment of the present invention.

A hologram image displaying apparatus according to an embodiment may display a hologram image by matching a pupil of a user and a hologram viewing window using a holographic display having a narrow viewing angle.

Referring to FIG. 7, in operation 701, an image acquiring unit may acquire a user image and output the acquired user image to an image analyzer.

In operation 702, the image analyzer may calculate center coordinates of the pupil of the user by detecting the pupil of the user through image processing. In operation 703, the image analyzer may calculate a change amount with a previous coordinate value of the pupil, and may compare the calculated change amount with a predetermined threshold. When the change amount is greater than or equal to the predetermined threshold, the image analyzer may transfer position coordinates of the pupil to a light source provider and a hologram creator in operations 704 and 705.

In operation 706, the light source provider may move a position of the light source so that a viewing window of zero-th diffraction light may be positioned at the position of the pupil. In operations 707 and 708, the hologram creator may generate a hologram only with respect to each of points of a 3D image capable of being observed only at the transferred position of the pupil, and may transfer the generated hologram to a hologram display unit. In operation 709, the image acquiring unit may acquire an IR image, and may output the IR image to the image analyzer. In operation 710, the image analyzer may calculate a position error value of the viewing window by calculating a center of an area “a” of zero-th diffraction light and first diffraction light, and may calculate a focal error value by analyzing a blurring level of zero-th diffraction angle. In operation 711, the image analyzer may compare the position error value of the viewing window and the focal error value with a predetermined threshold. When the error value is greater than or equal to the threshold, the image analyzer may transfer corresponding values to the light source provider in operation 712.

In operation 713, the light source provider may correct the position of the light source in order to correct the error position error value of the viewing window and the focal error value.

The hologram image displaying apparatus assumes that a position of a user varies and thus, may repeatedly perform the above function by periodically acquiring a user image and an IR image using the image analyzer.

According to embodiments of the present invention, it is possible to provide a user with a 3D image that is clearly reproduced from a hologram image by matching a hologram viewing window and a pupil of the user on a holographic display having a narrow viewing angle.

Also, according to embodiments of the present invention, there may be provided a hologram image displaying apparatus and method that may match a position of a pupil of a user and a hologram viewing window by repeatedly correcting an error between a position of the pupil of the user and a position of a light source.

Also, according to embodiments of the present invention, it is possible to provide a clear 3D image using a holographic display having a narrow viewing angle, and to commercialize a hologram service or the holographic display through compatibility with the related art.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for displaying a hologram image, the apparatus comprising:
an image acquiring unit to acquire a user image;
an image analyzer to track a position of a pupil of a user using the user image, and to track a position of a light source of a reflection hologram image that is reflected from appearance of the user;
a hologram creator to create a display hologram image corresponding to the position of the pupil of the user;
a light source provider to control a position of a light source of the display hologram image based on the position of the pupil of the user; and
a hologram display unit to display the display hologram image.

2. The apparatus of claim 1, wherein the image acquiring unit comprises:
a user image camera to acquire a pupil image of the user; and
an infrared (IR) image camera to acquire the reflection hologram image that is created by an IR light that is diffracted from the hologram display unit and thereby reflected.

3. The apparatus of claim 2, wherein the user image camera comprises:
a three-dimensional (3D) position tracking camera to track a 3D position of the pupil of the user in 3D space.

4. The apparatus of claim 1, wherein the image analyzer calculates a mismatching level between a position of a viewing window and the position of the pupil of the user based on the reflection hologram image.

5. The apparatus of claim 4, wherein the light source provider controls the position of the light source to match a position of the viewing window.

6. The apparatus of claim 1, wherein the image analyzer analyzes a center position error between a center position of the viewing window and a center position of the pupil of the user that is analyzed from the reflection hologram image, and transmits the analyzed center position error to the light source provider.

7. The apparatus of claim 6, wherein the light source provider corrects the center position of the viewing window and the center position of the pupil of the user to be matched therebetween based on the center position error.

8. The apparatus of claim 1, wherein the image analyzer analyzes a blurring level of the reflection hologram image and transmits the blurring level to the light source provider.

9. The apparatus of claim 1, wherein the hologram creator creates the display hologram image using points that are configured by a 3D image acquired at the position of the pupil of the user.

10. The apparatus of claim 1, wherein the hologram display unit comprises:
a light condensing unit to condense, on the pupil of the user, the light source of which wave front is modulated through the display hologram image.

11. A method of displaying a hologram image, the method comprising:
acquiring a user image;
tracking a position of a pupil of a user using the user image;
tracking a position of a light source of a reflection hologram image that is reflected from appearance of the user;
creating a display hologram image corresponding to the position of the pupil of the user;
controlling a position of a light source of the display hologram image based on the position of the pupil of the user; and
displaying the display hologram image.

12. The method of claim 11, wherein the acquiring comprises:
acquiring a pupil image of the user; and
acquiring the reflection hologram image that is created by an infrared (IR) light that is diffracted and thereby reflected.

13. The method of claim 12, wherein the acquiring of the user image comprises:
tracking a three-dimensional (3D) position of the pupil of the user in 3D space.

14. The method of claim 11, further comprising:
calculating a mismatching level between a position of a viewing window and the position of the pupil of the user based on the reflection hologram image.

15. The method of claim 14, further comprising:
controlling the position of the light source to match a position of the viewing window.

16. The method of claim 11, further comprising:
analyzing a center position error between a center position of the viewing window and a center position of the pupil of the user that is analyzed from the reflection hologram image.

17. The method of claim 16, further comprising:
correcting the center position of the viewing window and the center position of the pupil of the user to be matched therebetween based on the center position error.

18. The method of claim 11, further comprising:
analyzing a blurring level of the reflection hologram image.

19. The method of claim 11, wherein the creating of the display hologram image comprises:
creating the display hologram image using points that are configured by a 3D image acquired at the position of the pupil of the user.

20. The method of claim 11, wherein the creating of the display hologram image comprises:
condensing, on the pupil of the user, the light source of which wave front is modulated through the display hologram image.
